(19) United States
(12) Patent Application Publication
(10) Pub. No.: US 2014/0043156 A1
(43) Pub. Date: Feb. 13, 2014

(54) Interchangeable personal vehicle display

(71) Applicant: Kenneth J. Howk, JR., New Braunfels, TX (US)

(72) Inventor: Kenneth J. Howk, JR., New Braunfels, TX (US)

(21) Appl. No.: 13/507,966

(22) Filed: Aug. 9, 2012

(51) Int. Cl. B60Q 1/26

(52) U.S. Cl. 340/468

(57) ABSTRACT

A vehicle display device includes a power source, display screen, a microprocessor which includes a database and communications port. Various messages are input into the display device and stored in the database. The user selects a preloaded message(s) to be displayed on the display device.

There are no related patent applications.

The present application was not subject to federal research and/or development funding.

### TECHNICAL FIELD

Generally, the invention relates to a sticker sized thin display device for interchangeable use on an automobile. The term “interchangeable” refers to the ability of the display to be readily configured into an interior package whereby the display is fastened to an interior window surface of an automobile. In the alternative, the display may be configured to be fastened to an exterior of an automobile such as the rear, sides, or front. The display may be configured to reverse the display message such that it is correctly displayed on a rear view mirror of an automobile in front of the display. More specifically, the invention relates to a display device that includes an independent power supply which may be coupled to the power system of the automobile. The display includes a least one communication link and may comprise a plurality of communication devices for receiving a variety of messages from multiple media devices such as personal digital assistants, cellphones, a keypad, and other such data collection and entry devices. The display device may show a static message or a dynamic display which comprises a plurality of messages. In one mode the message is displayed in a forward manner such that one viewing the device can readily recognize a displayed message. In a second mode, the message may be displayed in reverse fashion such that it is easily viewed in a mirror. A variety of messages may be displayed on the sticker sized message board.

### BACKGROUND OF THE INVENTION

Various forms of communication have existed previously. Some of these forms include the written messages that are displayed on modes of transportation or along highways. Many of these displays include mobile displays, highway signs, and billboards. By way of example, the following patents and publications reflect various signs and means of conveying a message. U.S. Pat. Publication No. 2002/0121970 discloses an electronic vanity display device having an externally affixed vanity display screen. A display composition computer is used to create a composition of text, graphics, and digital photographs. The device connects to the internet through a wireless communications device.

U.S. Pat. No. 4,353,063 to Devlin discloses a bus destination sign with a programmed destination name and manually settable route numbers for a combined display. The destination sign for buses is provided with means for adding a route number to the display device independently of the destination name displayed on the sign. The destination sign is of the electronic type in which a long destination name is displayed by showing two or more word units in time sequence on the same display device. The word units are stored in memory. A destination name selector (14) and logic means (16) addresses the desired combination of word units in sequence. A route number selector (24) generates a route number signal independently of the destination name selector. The memory and the route number selector are selectively coupled by switching means (20) to a character generator (22) which controls the energizing of the display device according to the characters to be displayed in the destination message. A route number flag signal is stored in memory with short destination names and the flag signal controls the switching means so that the route number is automatically displayed with the short word unit of the destination name.

U.S. Pat. No. 4,361,828 to Hose discloses an automotive communication device. A vehicle communication system device consisting of an opto-electrical message display unit adapted to be viewed from the exterior of the vehicle and of a message control unit that is connected to the display unit for programming a message and transmitting an electrical pulse that causes the display unit to display the programmed message.

U.S. Pat. No. 4,574,269 to Miller discloses a vehicle communicator for a rear window of a vehicle. The communicator is semi-transparent and adapted to be disposed in the rear window of the vehicle for viewing from outside. The degree of transparency accommodates normal use of an inside rearview mirror of the vehicle by a driver of the vehicle. The communicator also includes a message display unit including a plurality of light emitting diodes in a matrix arrangement and disposed in a limited discrete portion of the rear window. The light emitting diodes are selectively energized to emit light in the form of a message. A message control unit connected to the light emitting diodes selectively energizes the light emitting diodes in any one of a plurality of preselected patterns. With this arrangement, the preselected patterns form messages for viewing from outside of the vehicle upon selective actuation of the message control unit.

U.S. Pat. No. 4,928,084 to Reiser discloses a combined message display and brake light having an array of light emitting diodes arranged to transmit a selected pattern or message in red light. A fixed or programmable memory has sets of data stored therein that can be selectively extracted to energize certain of the light emitting elements and display a single line of a selected message. Upon actuation of the brake of the vehicle in which the display screen is mounted, display of the message is disabled, and all of the light emitting elements are energized to provide a solid display of red over the entire screen. As a further safety feature, the display is maintained in a disable condition until initial application of the brake, and thereafter subsequent applications of the brake will cause display of the brake light over the entire display panel.

U.S. Pat. No. 4,949,071 to Hutchison discloses a vehicle communication device wherein a display unit is selectively mountable onto a rear shelf of an automobile adjacent a rear window, including a safety switch to automatically de-energize the display unit when improperly oriented relative to the rear window. Suspension hooks are included for selectively securing the display unit from rear or side windows of the automobile.

U.S. Pat. No. 5,053,746 to Taneo discloses a vehicle communication device and includes a visual display panel comprising a matrix of LED lights operative through a controller and keyboard. The panel is mounted toward the rear of a vehicle forward of the trunk lid. The panel includes bracket members for securing the panel to the vehicular trunk overlying a vehicular bumper. The panel may optionally include a hydraulic cylinder to pivot the panel for enhanced visual positioning relative to an positioned behind the automobile.

U.S. Pat. No. 5,218,629 to Dumond, Jr. et al. discloses a communication system for message display onboard mass transit vehicles. The communication system for displaying route specific messages onboard a plurality of mass transit vehicles operating along designated routes within a geographical area serviced by a cellular telephone network includes a transmitter connectable to any telephone in the telephone system. The transmitter transmits messages to any other addressable telephone number in the system. A cellular based visual communication unit is mounted onboard each of the vehicles with each of the units having an addressable telephone number. The transmitter and each cellular based visual communication unit cooperatively assure that the contents of the route specific messages transmitted from the transmitter via the cellular telephone system to the respective vehicle are received, stored and subsequently displayed in an error-free condition, regardless of whether or not the vehicles are mobile or stationary.

U.S. Pat. No. 5,426,414 to Flatin et al. discloses an enhanced auxiliary signaling device. The enhanced auxiliary signaling device of the present invention includes a housing mounted on the rear of a vehicle with a control unit electrically connected to the vehicle electrical system and to a display panel on the housing to display various alphanumeric and graphic messages in response to activation of signals in the vehicle electrical system. The activation of a vehicle turn signal will cause a first alphanumeric message to be displayed along with a first graphic display. The second turn signal will display the first alphanumeric message along with a second graphic display. Activation of both turn signals will activate a second alphanumeric message, simultaneous with the first and second graphic displays. The activation of the vehicle brakes will activate a second alphanumeric message and a third graphic display. The control unit includes a microprocessor which prioritizes message displays, such that only a signal alphanumeric message display is displayed simultaneous with one or more graphic displays.

U.S. Pat. No. 5,825,281 to McCreary discloses a method of displaying advertising messages where a message to be displayed is sent to the display device from an onboard processor after having been retrieved from memory. The message comes on with the automotive brake lights and remains on until the brakes are released. The message changes with each application of the brake lights and is a continuous loop of sequentially displayed messages. In an alternative embodiment, the display remains on in a dimmer mode until the next application of the brakes changes the message. Thus, the message may be displayed while brake lights are energized, or alternatively, once brake lights are extinguished the message goes to a tail light mode having a reduced illumination level, for example, half as bright.

U.S. Pat. No. 5,905,434 to Steffan et al. discloses a vehicle communication device having a remote control unit installed in the interior of a vehicle and a display unit located on the exterior of the vehicle. The display unit has an input from the remote control unit and an input from a vehicle interface module that has inputs from the vehicle such as the braking system and the turning signal system. The remote control unit is controllable by the driver in the vehicle and has a table of preset and preprogrammed messages selectable by the driver. The driver selects a message to be displayed and sends the message to the display unit. Any input to the vehicle interface module from the vehicle signaling systems overrides the signal input from the remote control unit unless the display unit is mounted on the front of the vehicle. The driver can select a message from a table of messages that are sequentially displayed on the remote control unit. The table of messages is stored on a flash memory in the remote unit and in a flash memory in the display unit. The table of messages in the remote unit is programmable via a USB programming port. The table of messages in the display unit can be programmed via an RF signal sent to the display unit by the remote unit.

U.S. Pat. No. 6,243,685 to Welch et al. discloses a voice operated interactive message display system for vehicles and designed for inter-vehicle and extra-vehicle communications. The system includes one or more display units having a matrix of light-emitting elements to transmit a message to other vehicles either to the front, rear, side, or combination thereof. The display units are controlled by a central control unit having a voice recognition and voice synthesis system, which is used to interactively determine a message to display and on which displays to present it. Upon manual activation, the message system vocally prompts the user for the message to display and the parameters for its display. The system may be implemented in at least two different embodiments. In one embodiment a powerful vocabulary memory unit is used and the content of the message is run-time programmable. If a less expensive vocabulary unit is used, the user may choose from a series of preprogrammed messages. Once specified, the message can then be delivered to the displays (front, rear, or side) in normal or mirror imaged formats. The display system can also monitor ambient light conditions to make appropriate brightness and contrast adjustments to maximize message readability.

U.S. Pat. No. 6,812,851 to Dekach et al. discloses an apparatus for displaying information on vehicles. A system for publicly displaying messages can comprise an automotive vehicle having an automotive electrical system including an ignition system and a generator and a publicly visible electronic display; video drive circuitry for generating images (which can include advertisements) on the display. Display-power circuitry receives power from the vehicle's automotive electrical system, supplies that power to the display, and automatically reduces the power supplied to the display after the vehicle's ignition is turned off. The display-power circuitry can automatically increase power to the display when the vehicle's ignition is turned back on. A computer can control the images on the display and the display-power circuitry can automatically reduce power to the display independently of whether the computer is operating. A system for publicly displaying messages can also comprise an automotive vehicle having a publicly visible electronic display. A computer shows various messages (which can include advertisements) on the display. An input device can be used by an occupant of the vehicle to generate one or more emergency signals and a connection supplying such emergency signals to the computer. The computer can respond to the emergency signal by showing an emergency message on the display. A radio can be connected to the computer to supply information to the computer about messages to be displayed and to respond to the generation of an emergency signal by sending an emergency message to a remote electronic system.

U.S. Pat. No. 6,880,276 to Strein et al. discloses a transparent electronic illuminated display which provides an illuminated electronic display that in one preferred form employs LED's to form characters in a message that is desired to be displayed to an intended viewer. A display of the invention is translucent, and is thus suitable for placement in locations which precluded locating illuminated electronic displays of the prior art in those same locations by virtue of the opaqueness of the displays of the prior art. A display means according to the invention may be placed in the rear window of an automobile, without adversely impacting the drivability of the vehicle owing to the translucency of the display. Other window locations are suitable for employment of a device according to the invention as well.

U.S. Pat. No. 7,142,104 to Blueford discloses a message display system. A message display system includes a main housing that couples to a vehicle. The main housing has bezel portion designed for encompassing a perimeter edge of a license plate. The main housing has a top display means for presenting a visual message. The top display means is medially positioned on a top portion of the main housing. A receiver portion is operationally coupled to the top display means. The receiver portion is positioned substantially within the housing. The receiver portion facilitates input of a message to be visually presented. A remote transmitter member is designed for receiving user input of a message to be visually presented. The remote transmitter member is operationally couplable to the receiver portion such that the message is communicated from the remote transmitter to the receiver portion.

U.S. Pat. No. 7,233,849 to Hill et al. discloses an automobile communication courtesy display. An automobile communication system is provided for communicating with others by displaying operator selected or input messages on a display mounted in the rear window of a vehicle. The operator may select messages on a keypad or by voice commands received by a microphone mounted in the vehicle. The system may include predetermined messages and may be programmed to include additional messages for display.

U.S. Pat. No. 7,378,948 to Somuah discloses a digital message display for vehicles. The digital message display for vehicles detects a tailgater and automatically flashes a warning message, directed to the tailgater, on a message display that is located in the rear window of the vehicle in view of following traffic. In addition to the warning message directed to the tailgater, a distance display is located in view of the vehicle driver to indicate the distance of the tailgater. An audible alarm alerts the driver to the presence of the tailgater. Additionally, a wireless remote control device allows the driver to manually select and display one of a number of pre-defined safety and courtesy messages. Multiple distance sensors provide multiple functional ranges to accommodate varying driving or traffic conditions.

U.S. Pat. No. 7,449,998 to Au et al. discloses an electronic display panels for automobiles and techniques for displaying messages on top of a vehicle. Although useful in many other areas, the techniques are particularly suitable for taxicab. According to one aspect of these techniques, a display unit is mounted on top of a vehicle. The display unit includes at least two display panels facing outward respectively. The display unit is controlled by a computing device to display various messages. In one embodiment, the vehicle is provided a Global Positioning System (GPS) that determines a location of the vehicle. Coupled to the GPS, the computing device sends the location information of the vehicle to a base station and receives returned information from the base station in accordance with the location information. The returned information, at least some of which are location based, is locally processed for suitable display on the display panels.

U.S. Pat. No. 7,478,492 to Madonia discloses an integrated flat panel display for mounting to exterior surfaces of motor vehicles. The flat panel display, such as LED or plasma display, is mounted flush to an exterior portion of a vehicle body. A protective rim surrounds at least a portion of the perimeter the display. A protective layer is disposed on a viewing surface of the display. A control circuit is coupled for controlling the display. A memory device is coupled to the control circuit for storing images. An operator control panel is coupled to the control circuit for controlling operation of the display. A communication link is coupled to the control circuit for receiving images for display on the flat panel display. A sensor is coupled to the control circuit for sending a sensor signal to the control circuit and causing an image to be displayed on the flat panel display.

U.S. Pat. No. 7,659,808 to Cooper et al. discloses an automotive messaging display unit which relates to communication systems, and more specifically to a vehicular messaging display unit. The unit allows one of a plurality of messages to be displayed on at least one of the front or rear windshield to other drivers. A remote control unit is provided for customizing messages by the user in terms of content and appearance as well as for controlling the display of the messages. The display is designed so that it does not impede the safety of drivers.

U.S. Pat. No. 7,696,865 to Robinson discloses an electronic message board for vehicles and associated method and includes a housing removably affixed to an interior surface of a selected window of a vehicle. Such housing is visible to another driver during driving conditions and includes a back wall with front and rear planar surfaces respectively and a first electrically conductive plate with a planar rear surface directly attached to the front surface of the back wall. The message board further includes a light display fitted within the housing, a light emitting diode array, a transparent faceplate with predetermined indicia formed in a front surface thereof, and a mechanism for selectively actuating the light display.

U.S. Pat. No. 7,866,861 to Alexander discloses a laminated device for selective presentations from the exterior of a mobile vehicle and method of use thereof. A mobile vehicle information device that is laminated to the glass surface of or laminated between glass pieces of a windshield or window is provided. The information device has illuminating and radiating properties that are operated by power consoles to permit selected illumination of the information for viewing external to the vehicle.

U.S. Pat. No. 7,952,489 to Paterno discloses a vehicle communication system and method of use. The system includes a display installed in, or on, a first vehicle such that the display is viewable by persons in other vehicles or pedestrians proximate the first vehicle. The display is communicatively linked to one or more vehicle systems or a vehicle controller area network whereby based on activation, engagement or utilization of a vehicle system, the display automatically displays a message associated with the activation, engagement or activation of the vehicle system. For example, if a driver of the vehicle applies the brakes, a “STOPPING” message is displayed. Messages may be pre-programmed into the system or custom created and entered by a user. The display may also be used to advertise, alert passersby to an emergency or otherwise communicate with persons in other vehicles or pedestrians.

U.S. Publication No. 2003/0227375 to Yong discloses an automotive courtesy display system allows the driver of an automotive vehicle to visually display courtesy messages to the drivers of vehicles located to the rear. Such messages may be for an occasional urgent request to “cut in” for safe passage. The message display system provides the driver of the vehicle in which the visual display is installed with an audible feedback so that the vehicle driver can verify that the correct message has been selected, without visually distracting the driver's attention. The system includes three main components, namely a wireless control unit located on the vehicle operator's steering wheel, a processor unit containing most of the electronics of the system positioned in an unobtrusive location so as to avoid impairing the drivers view, and one or a pair of display screens which are typically located behind the rear seat headrests of an automotive passenger vehicle. A microprocessor controller within the microprocessor unit selects a text message corresponding to the particular touch sensor depressed, and transmits it to an appropriate one the display screens. The audible announcement of the message selected by the touch sensor provides the operator with a positive feedback indicating selection of the correct message.

U.S. Publication No. 2004/0187371 to Maqui et al. discloses a digital display and message device for use on a vehicle having an interior and an external appearance comprises a processing unit including a memory storage device for location in the vehicle. A power connector connects the processing unit to a source of power. A data input mechanism is provided for inputting data comprising text and/or images to the memory storage device. A display screen located on or in the vehicle then displays the text and/or images received from the processing unit such that the text and/or images are formed and can be observed as part of the external appearance of the vehicle.

U.S. Publication No. 2006/0167745 to Wiethorn discloses a method for providing low-cost message display boards. Embodiments of the present invention relate to providing low-cost message display boards to users of a message display board service. According to one embodiment of the present invention, display boards capable of displaying a user designated message are supplied by a provider of a message display board service for free or for a very low cost. The user may then use the display board to display personalized messages designated by the user. In exchange for use of the low-cost or no-cost display board, the user accepts that the display board is adapted to receive periodic, supervening messages from the service provider that will be temporarily displayed on the display board in place of any user designated message. The supervening messages transmitted by the service provider may be advertising messages supplied by the service provider or one or more third party advertisers who pay a fee to the service provider in exchange for the display of the ads on display boards of the users.

U.S. Publication No. 2008/0284578 to Mouratidis discloses an automobile communication device which includes a housing operably connectable to an automobile and having a rearward facing transparent portion. A display mechanism having sides each with predetermined indicia thereon is rotatably disposed within such housing. A motor is operably connected to the display mechanism for rotating the display mechanism. A power source is operably connected to the motor. A switch mechanism is operably connected to the power source. A control mechanism is operably connected to at least one of the display mechanism, such automobile, the power source, the motor, the switch mechanism, and a combination thereof for enabling a user to select a predetermined side of the display mechanism for being at least one of rearward facing and visible through such portion. A stop mechanism is operably connected to at least one of the display mechanism, the housing, and a combination thereof for stopping the display mechanism from rotating.

U.S. Publication No. 2011/0013109 to Bryan discloses a solar power message display for windows. A LCD display device displays messages, announcements, pictures, logos and other expressions from the interior of a vehicle to be seen from outside. The display device utilizes miniature solar or regular batteries for cordless installation. It can be attached on a window using Velcro, suction cups or hooks. The back side of the device comprises a second display device, a notepad, a white board, a reading light, a GPS holder, or an air freshener holder.

### SUMMARY OF THE INVENTION

The invention is a display for use on automobiles or other modes of transportation. The display is a clear, flexible display technology with an electro-adhesive surface that allows it to be emplaced onto an interior or exterior surface that utilizes a static electrical charge to adhere the display onto an interior or exterior surface of an automobile. The adhesive may be clear and non-tacky to the touch or otherwise clear, opaque, unclear and tacky to the touch. The substrate onto which the circuits are deposited is clear flexible plastic. The wiring and paths of the electrical conductors may be mostly formed within a frame member that may be clear or opaque. Otherwise, clear conductors may be used in the display.

The term “electro-adhesive surface” refers to a flexible substrate having an adhesive on one side of an electrical display device. A disposable pull-off covers the adhesive and is removed prior to installing the display onto an exterior. The adhesive may be provided in strips or in an entire sheet covering substantially one face of the device. The electrical display device comprises a planar display screen side comprising an array of light emitting diodes, a liquid crystal display screen, or the like. An on-board central processing unit (CPU) includes a database of stored messages and controls data output to the display screen. Various inputs, both wireless and wired, are provided to the CPU for uploading and storing a variety of messages. These messages may be easily accessed for display. A direct current power source such as a battery, solar cell, capacitor, or automobile electrical system is used to power the display. The display is preferably clear when not conveying a message. The CPU includes a database with a plurality of stored messages but will be programmable via a computer, smart phone or the like through wired or wireless connections.

The purpose of the product is to display messages or other media in order to communicate a message. The display receives instructions and its messages via direct (wired) and/or indirect (wireless) methods. It receives its instructions through application-based software, either directly (wired) through a computer interface or indirectly (wireless) from a smart phone application. The message entry application utilizes either keyboard text input or voice-to-text technologies to provide on-the-go, real-time message changes or updates. The product utilizes Bluetooth or other similar security protocols, requiring a unique passcode to change display properties. The passcode may be changed by the user. The product receives its power via direct interface with an external power source, a battery pack, externally affixed solar panels, or a kinetic energy capture device delivering a steady stream of power to a rechargeable battery. The smart phone application allows for user-defined preset messages, standardized messages, dimming and brightness settings, scrolling, and general adjustment of display parameters. Proprietary voice recognition software may also enable communication with the display device. The display device is capable of receiving video signals from external video sources. It can be used by the user to display messages to other individuals, or to display information used by the user.

It is an object of the invention to teach an automobile display device that may be used on an exterior or interior and includes an input for uploading a message that is displayed on the device.

It is further object of the invention to disclose a bumper sized sticker that may be fastened onto a surface of an automobile.

Additional objects and advantages of the invention will be set forth in part in the description which follows, and in part will be obvious from the description, or may be learned from practicing the invention. The objects and advantages of the invention will be obtained by means of instrumentalities in combinations particularly pointed out in the appended claims.

### BRIEF DESCRIPTION OF THE DRAWINGS

FIG. 1A is a perspective view of the display device. FIG. 1B is a view of the first end of the display device. FIG. 1C is a view of the second end of the display device.

FIG. 2 is a schematic view of the display device showing a wireless input device.

FIG. 3 shows the display configured to be on the inside of an automobile window

FIG. 4 shows a display device on an exterior surface of an automobile.

### DETAILED DESCRIPTION OF THE INVENTION

The embodiments of the invention and the various features and advantageous details thereof are more fully explained with reference to the non-limiting embodiments and examples that are described and/or illustrated in the accompanying drawings and set forth in the following description. It should be noted that the features illustrated in the drawings are not necessarily drawn to scale, and the features of one embodiment may be employed with the other embodiments as the skilled artisan recognizes, even if not explicitly stated herein. Descriptions of well-known components and techniques may be omitted to avoid obscuring the invention. The examples used herein are intended merely to facilitate an understanding of ways in which the invention may be practiced and to further enable those skilled in the art to practice the invention. Accordingly, the examples and embodiments set forth herein should not be construed as limiting the scope of the invention, which is defined by the appended claims. Moreover, it is noted that like reference numerals represent similar parts throughout the several views of the drawings.

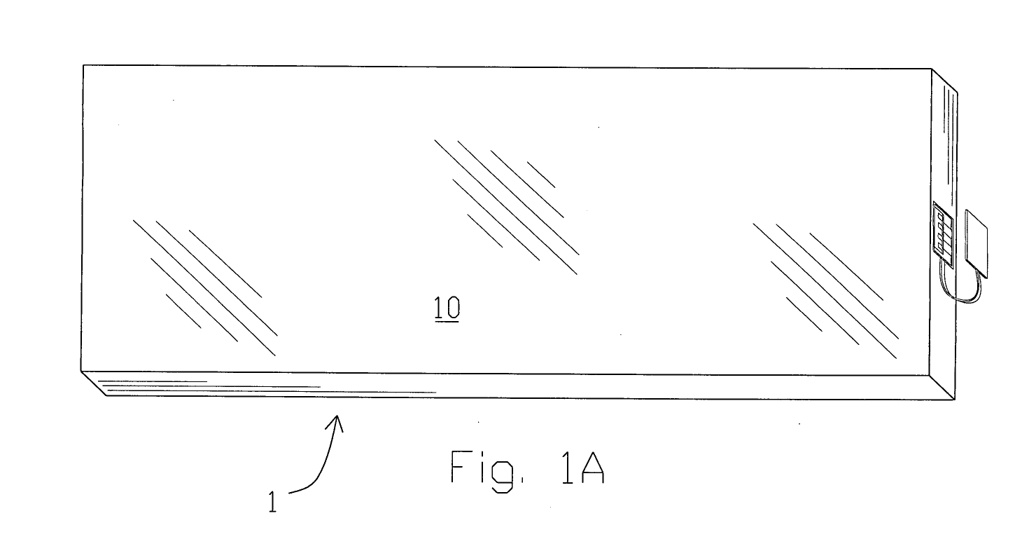

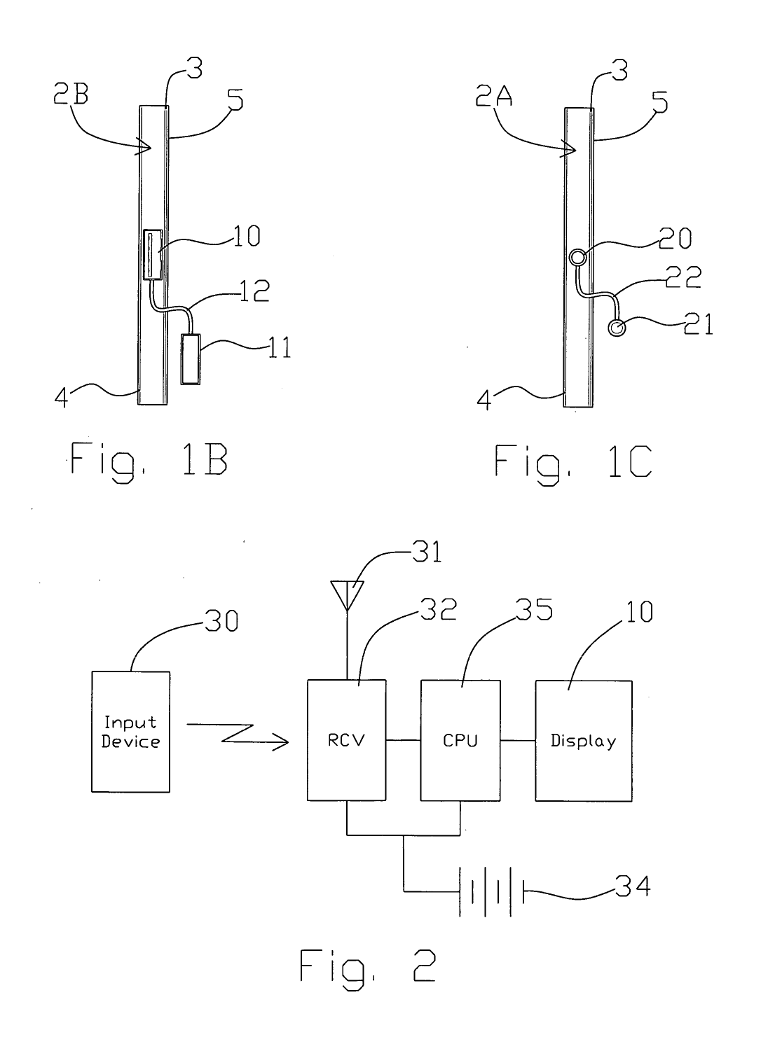

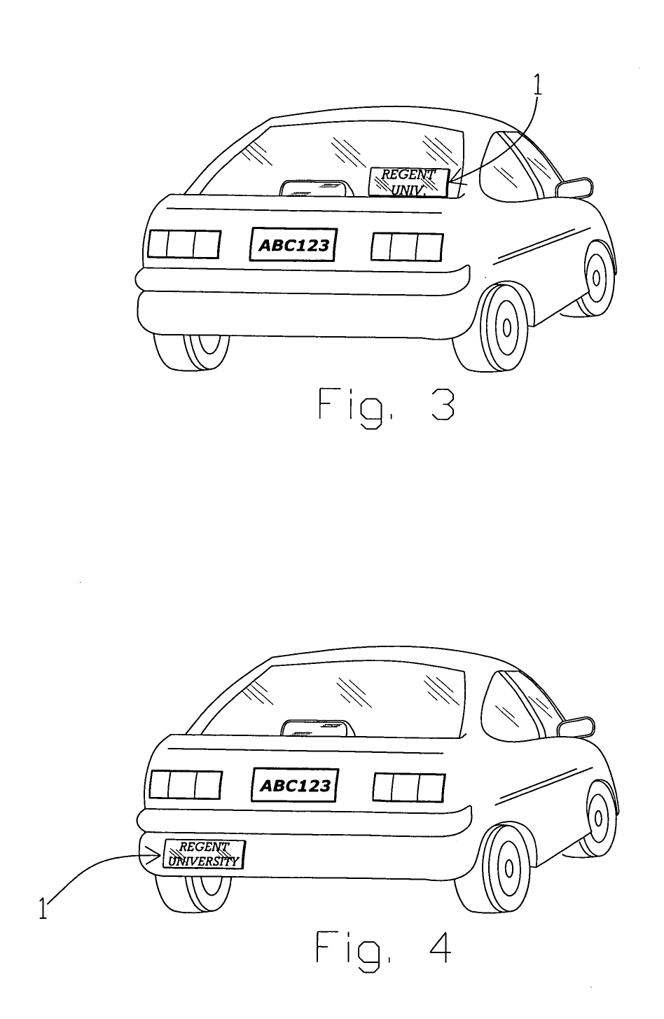

FIGS. 1A-1C are views of one embodiment of the instant invention. A display screen 10 is formed in the generally rectangular shape as shown in the front view. A removable protective overlay 5 protects the display device 1 from adverse environmental conditions when the display device is attached to the exterior of an automobile. The protective overlay 5 may comprise clear acrylic Plexiglas or other such material which shields to display from damage. The protective overlay 5 may be removed and replaced with a sheet of clear adhesive 3 if the display device 1 is fastened to an interior surface of an automobile window as shown in FIG. 3.

The display screen 10 is clear and is preferably see-through when not energized, such that it is not easily noticeable. In its simplest form, a contrasted message is displayed by darkening the background of the display and allowing lettering, symbols, picture, or messages to be shown in lighter contrast(s) of color or shades. Otherwise the display may remain substantially transparent and the lettering, picture or messages may be displayed by simply darkening them on the transparent screen. It is contemplated that multiple colored screens may be implemented. As can be understood, the display includes a double-sided adhesive 3 on one side thereof.

A protective overlay 5 is provided on the face of the adhesive opposite the back of the display and is removed when prior to mounting the display device 1 onto an exterior surface of an automobile as shown in FIG. 4. A protective removable overlay 5 extends across the entire exposed outer face for use as a protective shield when used on an exterior of an automobile. This protective shield may be replaced with a clear layer of adhesive if the display is mounted in the interior of the automobile. The overlay 14 is removed to expose an adhesive that is sticky and which fastens the display device onto an automobile surface.

It is contemplated that the display screen may be fastened via a variety of external fasteners if the invention is implemented in a heavier package which may include LEDs and associated driver circuitry. The device may be provided with a variety of externally wired inputs including both a data input (USB) 10 that includes a removable dustcover 11, as shown in FIG. 1B. Lanyard 12 couples the removable dustcover 11 to an end of the display device 1. Data input 10 allows an external device to upload a graphics package for display. On an opposite end, a power input 20 includes a removable dustcover 21. Power input 20 is utilized for providing an external power source for use with the display device 1. Lanyard 22 couples the power input dustcover 21 to an end of the display device 1 as shown.

FIG. 2 is a schematic view showing a wireless input device 30 which may be wirelessly coupled to the display 10. A wireless connection is established between the input device 30 and CPU 35 via antenna 31 and receiver 32. A power source 34 connects to the receiver 32 and CPU 35 and provides power thereto. An output from CPU 35 provides an input of data to the display 10. The USB 20, not shown in FIG. 3, connects to the CPU 35 for providing an alternative input. The display comprises a clear, flexible display technology having a clear substrate with a clear adhesive surface that allows it to be emplaced onto any automobile surface. The substrate onto which the circuits are deposited is clear flexible plastic. The wiring and paths of the electrical conductors may be mostly formed within a frame member that may be clear or opaque. Otherwise, thin film transistors may be deposited onto a clear plastic support substrate to implement the display. The display comprises an antenna if controlled by a wireless hand-held device or controller. The antenna receives a wireless control signal coded with a password and a message to be displayed from the wireless control device. The message to be displayed may be included in a database stored in either the wireless controller or a memory within the display. A transceiver in the display allows the wireless hand-held device to communicate with the user. Decoder circuitry is provided for processing a received signal to strip the password and display message from the coded signal.

A hardwired remote device may be used in controlling the display in lieu of wireless controller. In the preferred embodiment, the message entry application utilizes either keyboard text input or voice-to-text technologies to provide on-the-go, real-time message changes or updates to the display. The product receives its power via direct interface with an external power source, a battery pack, externally affixed solar panels, or a kinetic energy capture device delivering a steady stream of power to a rechargeable battery. A smart-phone application allows for user-defined preset messages, standardized messages, dimming and brightness settings, scrolling, and general adjustment of display parameters. Voice recognition software may also enable communication with the display device. The display device is capable of receiving video signals from external video sources and displaying them.

As shown in FIGS. 3-4, the display device may be affixed to either an interior or exterior of an automobile. A message is generated by the user and transmitted to the CPU. A passcode is provided to authenticate the user. The CPU determines whether the message is to be continuously displayed or scrolled across the display screen. If the display is not continuously displayed, it is dumped into a cue of messages to be periodically displayed in a marquee type display. If the message is continuously displayed, then it is forwarded to the display screen. As represented in FIG. 3, the clear electro-adhesive display device 1 is attached to an interior window surface. Overlay 5 is removed and discarded prior to installation of the display

It is to be understood that the invention is not limited to the exact construction illustrated and described above, but that various changes and modifications may be made without departing from the spirit and the scope of the invention as defined in the following claims. While the invention has been described with respect to preferred embodiments, it is intended that all matter contained in the above description or shown in the accompanying drawings shall be interpreted as illustrative and not in limiting sense. From the above disclosure of the general principles of the present invention and the preceding detailed description, those skilled in the art will readily comprehend the various modifications to which the present invention is susceptible. Therefore, the scope of the invention should be limited only by the following claims and equivalents thereof.

I claim:

1. A personal vehicle display device comprising:
a substantially transparent screen having a front face and a back face;
a power supply providing electricity to the personal vehicle display device;
a microprocessor that stores a variety of messages and having an input for receiving data representative of a message to be displayed and an output and being connected to the power supply to receive power there from, said microprocessor including a data output that outputs data representative of a message to be displayed;
a data input port affixed at one end of the substantially transparent screen and connected to the input of the microprocessor, said data input port receiving data from an input device, said data comprising a message to be displayed on the personal vehicle display device;
a wireless communication input connected to an input of the microprocessor that receives wireless messages; and,
an adhesive surface arranged on an exterior of one of the back face of the substantially transparent screen and the front face of the substantially transparent screen and which couples the substantially transparent screen to a surface of an automobile.

2. The personal vehicle display device of claim 1 further comprising:
a power input port connected to the power supply and for routing electricity into the power supply.

3. The personal vehicle display device of claim 2 further comprising
a dustcover that is removeably affixed to the power input port.

4. The personal vehicle display device of claim 1 further comprising:
a dustcover that is removeably affixed to the data input port.

5. The personal vehicle display device of claim 1 further comprising:
a removable protective overlay affixed on the front face of the substantially transparent screen.

6. The personal vehicle display device of claim 1 further comprising:
a wireless input device wirelessly connected to the microprocessor via an antenna and receiver.

7. The personal vehicle display device of claim 1 further comprising:
a passcode programmed into the microprocessor and which prevents unauthorized use of the personal vehicle display.

8. A personal vehicle display device comprising:
a substantially transparent screen having a front face and a back face;
a removable protective overlay affixed on the front face of the substantially transparent screen;
a power supply providing electricity to the personal vehicle display device and a power input port connected to the power supply and for routing electricity into the power supply;
a dustcover that is removeably affixed to the power input port;
a microprocessor that stores a variety of messages and having an input for receiving data representative of a message to be displayed and an output and being connected to the power supply to receive power there from, said microprocessor including a data output that outputs data representative of a message to be displayed;
a data input port affixed at one end of the substantially transparent screen and connected to the input of the microprocessor, said data input port receiving data from an input device, said data comprising a message to be displayed on the personal vehicle display device;
a dustcover that is removeably affixed to the data input port;
a wireless communication input connected to an input of the microprocessor that receives wireless messages; and,
an adhesive surface arranged on an exterior of one of the back face of the substantially transparent screen and the front face of the substantially transparent screen and which couples the substantially transparent screen to a surface of an automobile.

9. The personal vehicle display device of claim 8 further comprising:
a wireless input device wirelessly connected to the microprocessor via an antenna and receiver.

10. The personal vehicle display device of claim 8 further comprising:
a passcode programmed into the microprocessor and which prevents unauthorized use of the personal vehicle display.
